(19) United States
(12) Patent Application Publication
(10) Pub. No.: US 2013/0053814 A1
(43) Pub. Date: Feb. 28, 2013

(54) DEVICE

(71) Applicants: Andreas Mueller-Beckhaus, Madison, NJ (US); Kevin Prosise, Benicia, CA (US); Edward Cheng, San Francisco, CA (US); Peter Kramer, Berkeley, CA (US); Patrick Ryan, West Hollywood, CA (US); Andrew Coats, Sommerville, MA (US); Robert Dyer, Concord, MA (US)

(72) Inventors: Andreas Mueller-Beckhaus, Madison, NJ (US); Kevin Prosise, Benicia, CA (US); Edward Cheng, San Francisco, CA (US); Peter Kramer, Berkeley, CA (US); Patrick Ryan, West Hollywood, CA (US); Andrew Coats, Sommerville, MA (US); Robert Dyer, Concord, MA (US)

(73) Assignee: Bayer HealthCare LLC, Tarrytown, NY (US)

(21) Appl. No.: 13/522,481

(22) PCT Filed: Jan. 18, 2011
(86) PCT No.: PCT/US11/21580

§ 371 Date: Nov. 12, 2012

Related U.S. Application Data
(60) Provisional application No. 61/295,679, filed on Jan. 15, 2010.

(51) Int. Cl. A61J 1/20

(52) U.S. Cl. 604/414

(57) ABSTRACT

The present application is directed to devices. The device may used for connecting a closed receptacle and a container, such as a syringe.

### REFERENCE TO RELATED APPLICATIONS

This application claims priority to U.S. Provisional Application Ser. No. 61/295,679 filed on Jan. 15, 2010 and is hereby incorporated by reference for all purposes.

### FIELD OF THE INVENTION

The present application is directed to devices. The device may be used for connecting a closed receptacle and a container, such as a syringe. As an example, the device may be used to reconstitute a drug product, or to combine two separate components.

### BACKGROUND

For certain chronic diseases such as hemophilia, diabetes, and multiple sclerosis, it is often necessary for patients suffering from these diseases to self-administer their medication. Often, these medications are available in a lyophilized form; and therefore, it is necessary for the patient or caregiver to reconstitute this medication. Reconstitution may require the use of a syringe to introduce diluent into a vial containing the medication, and possibly subjecting the patient or caregiver to accidental needle sticks. Hence, there is a need for a device that is safe to use for both patients and caregivers.

Another factor to consider for such a device is ease of use. For patients and caregivers, a complicated device may lead to reconstitution failure, contamination, or incorrect dosing. Similarly, untrained health care professionals, particularly in an emergency situation, may also face the same problems. Furthermore, a complicated device may have an impact on patient compliance. Therefore, it would be beneficial to patients, caregivers, and untrained health care professionals to have access to a convenient, safe, and easy-to-use device.

Other factors to consider are waste of medication and unnecessary costs. That is, a device that is easy-to-use may limit the loss of medication due to improper reconstitution. Also, for prevention of contamination, the device may be a single use device, and as such may include a mechanism to prevent reuse of the device.

Accordingly, there is a need for a safe, convenient, and easy-to-use device that limits the potential for reconstitution failure, contamination, or incorrect dosing and thus would be beneficial to patients and caregivers.

### SUMMARY OF THE INVENTION

The invention is directed to a device comprising: a receptacle including an opening surrounded by a neck; an inner sleeve including a first end, a second end, and an inner bore having a central aperture, the first end having a flexible skirt that is secured to the receptacle, the flexible skirt including one or more webbed protrusions extending outwardly from the inner bore, the webbed protrusions including one or more tabs that grip the neck of the receptacle; an outer sleeve including a first end and a second end, the outer sleeve surrounding the flexible skirt of the inner sleeve which pushes against the flexible skirt to secure the inner sleeve to the receptacle; a stopper located in the opening of the neck of the receptacle, the stopper including a portion capable of being perforated; a spike assembly adapted to slide along the inner bore of the inner sleeve, the spike assembly having a shaft capable of perforating the stopper; an outer cover surrounding the spike assembly and the inner sleeve and having an inner projection member extending downwardly from the top of the outer cover; a locking mechanism including a clip coaxially aligned with the shaft of the spike assembly, the clip capable of flexing to lock the spike assembly in an activated position in which the shaft is perforating the stopper; and an actuating mechanism for moving the spike assembly into the activated position comprising a first helical path located on an outer surface of the spike assembly and a corresponding second helical path located on the inner projection member of the outer cover, the first and second helical paths interacting to rotate and push the spike assembly downwardly into the activated position so the shaft of the spike assembly perforates the stopper.

In one embodiment, the outer sleeve of the device may include a lip which fits underneath the webbed protrusions of the flexible skirt to hold the flexible skirt in place. The outer sleeve may also include one or more slots and/or one or more ridges. The clip of the locking mechanism further may include one or more protrusions. The spike assembly of the device further may include a male element for receiving a second receptacle. The male element may include an inner bore and an outer surface including a thread. The second receptacle of the device may be a syringe. The spike assembly of the device may also include one or more tabs which engage the one or more openings of the inner sleeve.

In another embodiment, the spike assembly may include a filtering mechanism and at least one channel for establishing fluid communication between the inside of the receptacle and the inner bore of the male element. The shaft of the spike assembly may include a branched channel and an air channel. The locking mechanism of the device may be located in the inner sleeve. The locking mechanism may be secured to the spike assembly. The spike assembly may include at least one rib located on the surface of the spike assembly for aligning the spike assembly with the inner sleeve. The outer cover of the device may include at least one finger grip.

In a further embodiment, the device may comprise a drug product or pharmaceutical composition. The device may be a single use device. The device may also include a use indicator and/or a tamper-evidence indicator. The tamper-evidence indicator may be a seal, holographic label, a tab, or the like.

The invention is also directed to a method of actuating a device comprising providing a spike assembly adapted to slide along an inner bore of the inner sleeve, the spike assembly having a shaft capable of perforating the stopper, the spike assembly further including a first helical path on an outer surface; providing an outer cover surrounding the spike assembly and the inner sleeve and having an inner projection member extending downwardly from the top of the outer cover, the outer cover further including a second helical path located on the inner projection member; rotating the outer cover so the second helical path interacts with the first helical path to rotate and push the spike assembly downwardly into an activated position in which the shaft of the spike assembly perforates the stopper; and locking the spike assembly in the activated position by a locking mechanism.

In additional embodiments of the device, the device may be activated by a user rotating the outer cover and then pushing the outer cover downward which would then cause the spike assembly to perforate the stopper or the user may simply push the outer cover downward to cause the spike assembly to perforate the stopper. In another embodiment, the device may include a locking mechanism comprising a barb lock as a means to prevent the upward movement of the spike assembly after downward movement of the spike assembly has occurred.

The invention is also directed to a kit containing a device and a prefilled diluent syringe. The kit may further comprise an infusion set. In another embodiment, the kit may also comprise an alcohol swab, a cotton pad, and a bandage.

In another embodiment, the device may function as a channel between two compartments (e.g., sterile vial or bag). For example, the device may maintain the separation of two components prior to activation. Upon activation of the device, the channel is opened, allowing the transfer of the two components, and thereby combining the components.

### DESCRIPTION OF THE DRAWINGS

FIG. 1 is an illustration of the device.

FIG. 2 is an expanded view of the stopper and receptacle.

FIG. 3A is an expanded view of the inner sleeve. FIGS. 3B and 3C are perspective views of the inner sleeve.

FIG. 4A is an expanded view of the outer sleeve. FIGS. 4B and 4C are perspective views of the outer sleeve.

FIG. 5A is an expanded view of the spike assembly illustrating the locking mechanism. FIG. 5B is a perspective view of the clip of the locking mechanism and FIG. 5C is a perspective view of the inner sleeve.

FIGS. 6A, 6B, and 6C are perspective views of the spike assembly. FIGS. 6D and 6E are expanded views of the spike assembly illustrating a filtering mechanism.

FIG. 7A is an expanded view of the spike assembly illustrating the air and fluid channels. FIG. 7B is an expanded view of the shaft.

FIG. 8 is an expanded view of the shaft illustrating the air and fluid channels.

FIG. 9 is an expanded view of the spike assembly illustrating the activating mechanism.

FIG. 10A is expanded view of the outer cover and FIGS. 10B and 10C are perspective views of the outer cover. FIGS. 10D and 10E are perspective views of the ratcheting mechanism.

FIG. 11A exemplifies the attachment of the device to a vial and FIG. 11B is a perspective view of the attachment.

FIG. 12 is expanded view of the device illustrating the elements of the device.

### DESCRIPTION OF THE INVENTION

It is to be understood that this invention is not limited to the particular device or parts described and as such may vary. It is also to be understood that the terminology used herein is for the purpose of describing particular embodiments only, and is not intended to limit the scope of the present invention which will be limited only by the appended claims.

It must be noted that as used herein and in the appended claims, the singular forms “a,” “and,” and “the” include plural reference unless the context clearly dictates otherwise. Thus, for example, reference to “a tab” is a reference to one or more tabs and includes equivalents thereof known to those skilled in the art, and so forth. Unless defined otherwise, all technical and scientific terms used herein have the same meaning as commonly understood to one of ordinary skill in the art to which this invention belongs.

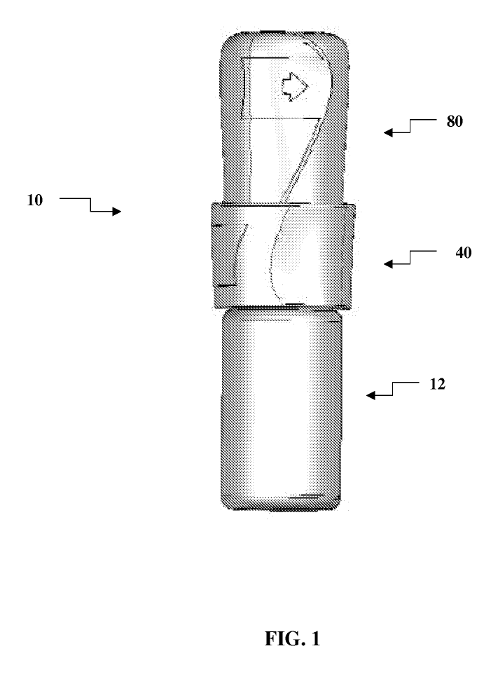

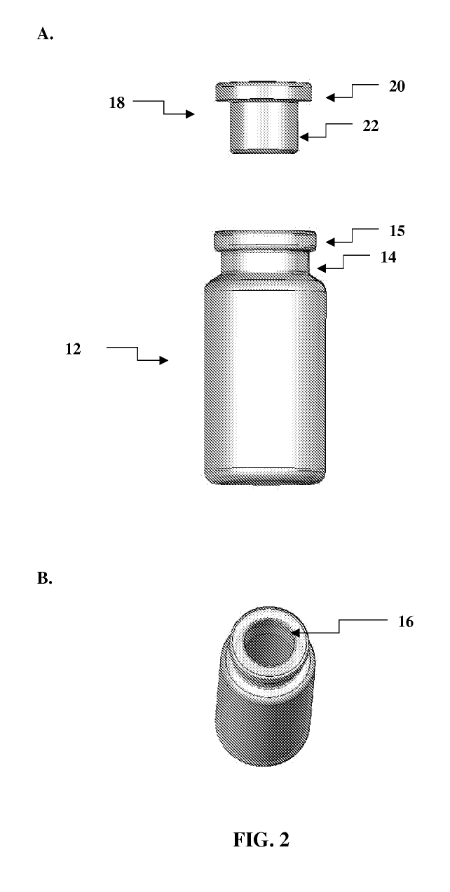

The present invention is directed to a device 10 (FIG. 1). The device 10 may include a receptacle 12 for storing a first component such as, a pharmaceutical composition or a drug product. The receptacle may be a bottle or vial, for example, a glass vial, or a bag, for example, an IV bag. The receptacle 12 may include an opening 16 surrounded or partially surrounded by a neck 14. The neck 14 may also include a lip 15. The opening 16 in the neck 14 allows for a second component, such as a liquid (e.g., a diluent), to be introduced into the receptacle 12 and mixed with the first component. A stopper 18 may be positioned in the opening 16 of the neck 14 to block access to the receptacle 12. The stopper 18 may be, for example, a two-leg, three-leg, or round bottom stopper and made of a relatively non-rigid material, for example, a polymer such as an elastomer. The stopper 18 may include a top portion 20 located against the lip 15, and a bottom portion 22 located within the opening of the neck 14. The top portion 20 may be capable of being perforated, thereby allowing access to the receptacle 12. See FIG. 2.

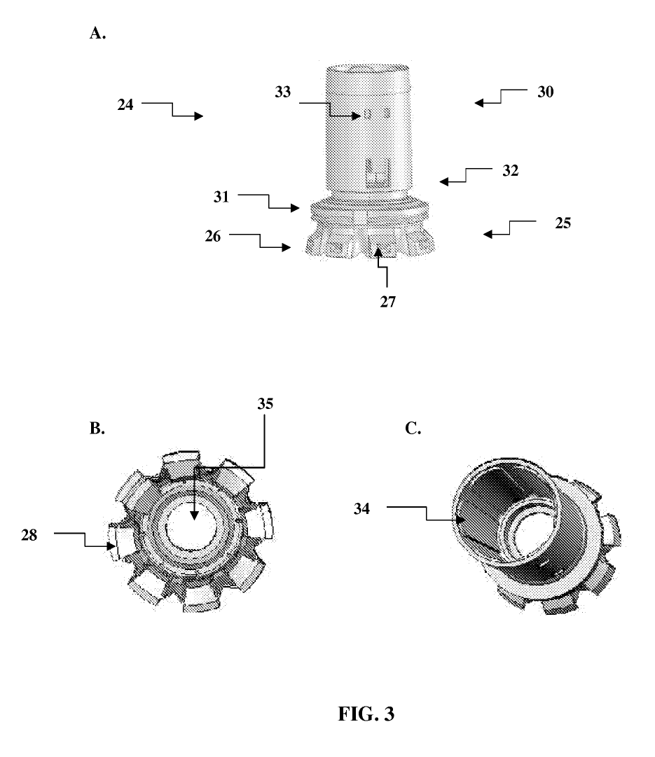

The device 10 may further include an inner sleeve 24 secured to the neck 14 of the receptacle 12. The inner sleeve 24 may have a first end 25, which is secured to the neck 14 of the receptacle 12, a second end 30 located opposite the first end 25, and an inner bore 34 with a central aperture 35. The first end 25 of the inner sleeve 24 has a flexible skirt 26 that is secured to the receptacle 12 and may surround at least a portion of the stopper 18. The flexible skirt 26 may include one or more webbed protrusions 27 which extend outwardly from the inner bore 34. The webbed protrusions 27 may include one or more tabs 28 which grip the neck 14 of the receptacle 12. As such, the inner sleeve 24 can expand to fit over the lip 15 of the neck 14 during the capping process, and then contract to securely mate with the neck 14. The inner sleeve 24 may further include a step portion 31 located between the first end 25 and the second end 30, thereby separating the first end 25 from the second end 30. The inner sleeve 24 may also include an O-ring 32 located at the step portion 31. The first end 25 of the inner sleeve 24 may have a larger diameter than the second end 30 of the inner sleeve 24. The second end 30 may also include one or more openings 33 which may be used to secure the spike assembly 50 at the second end 30 of the inner sleeve 24. See FIG. 3.

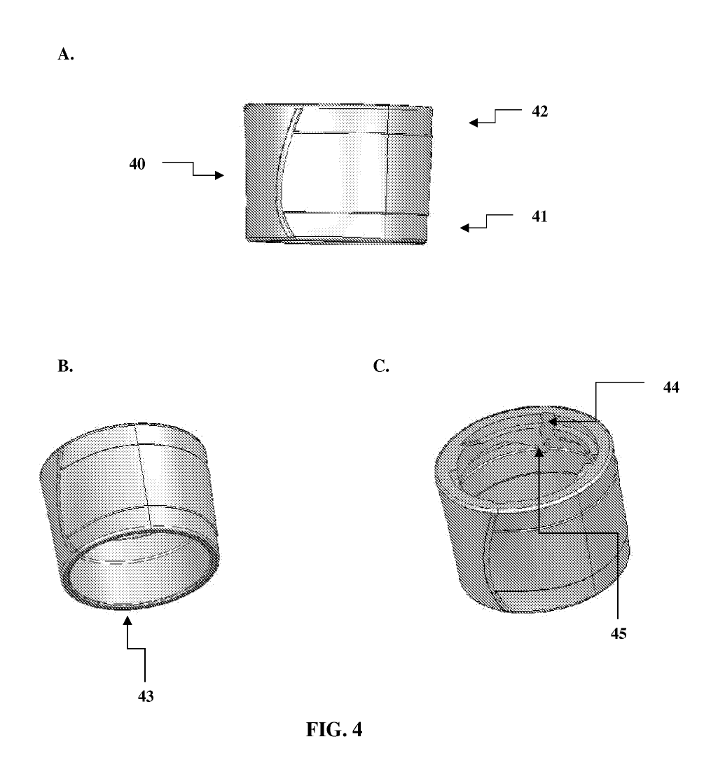

The first end 25 of the inner sleeve 24 may be surrounded by an outer sleeve 40. The outer sleeve 40 surrounds the flexible skirt 26 of the inner sleeve 24 and pushes against the flexible skirt 26 to secure the inner sleeve 24 to the receptacle 12. The outer sleeve may have a first end 41 and a second end 42. The first end 41 of the outer sleeve 40 may include a lip 43 which fits underneath the webbed protrusions 27 of the flexible skirt 26 to hold the flexible skirt 26 in place. The second end 42 of the outer sleeve 40 may also include one or more slots 44 and a ridge 45. The slots 44 and ridge 45 of the outer sleeve 40 may be used to engage and secure the outer cover 80. The outer sleeve 40 may further include a textured surface to facilitate gripping the device 10 by a user. The outer sleeve 40 may also include one or more finger grips. See FIG. 4.

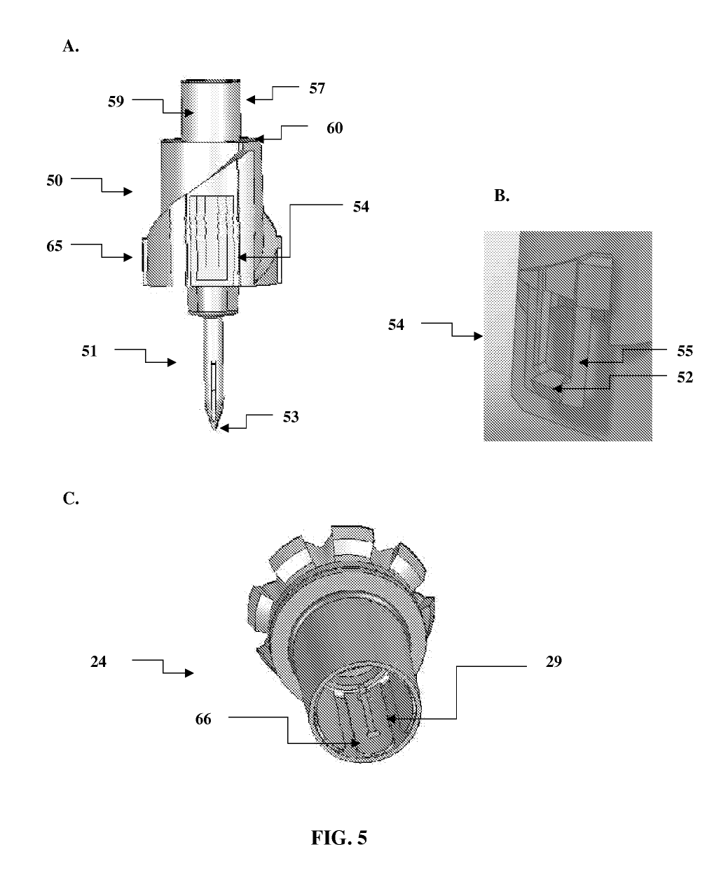

The device 10 may further comprise a spike assembly 50 adapted to slide along the inner bore 34 of the inner sleeve 24. The spike assembly 50 may be located at the second end 30 of the inner sleeve 24. The spike assembly 50 may further comprise a tab 52 which engages an opening 33 on the inner sleeve 24 and secures the spike assembly 50 at the second end 30 of the inner sleeve 24. The spike assembly 50 may also include one or more ribs 65 located on the surface of the spike assembly 50. The one or more ribs 65 of the spike assembly 50 allow for alignment with the one or more grooves 66 of the inner sleeve 24. The spike assembly 50 includes a shaft 51 capable of perforating a stopper 18. The shaft 51 extends downward in a direction towards the stopper 18. The shaft 51 may include a pointed end 53 for piercing the top portion 20 of the stopper 18, thereby allowing the shaft 51 access to the receptacle 12. The pointed end 53 may be straight or angled. In one embodiment, the shaft 51 may be elliptical-shaped (e.g., oval shaped). In another embodiment, the shaft 51 may have a cylindrical shape or a rectangular shape. See FIG. 5.

The device 10 may include a locking mechanism 54 for preventing upward movement of the spike assembly 50 after downward movement of the spike assembly 50 has occurred. In this manner, the device 10 may be prevented from multiple uses by restraining the spike assembly 50 in an engaged position, that is, when the shaft 51 pierces the stopper 18. The locking mechanism may be located in the inner sleeve. The locking mechanism 54 includes a clip 55 coaxially aligned with the shaft 51 of the spike assembly 50. The clip 55 is capable of flexing to lock the spike assembly 50 in an activated position in which the shaft 51 has perforated the stopper 18. The clip 55 engages a ridge 29 located on the inner bore 34 of the inner sleeve 24. Once engaged, the clip 55 prevents the spike assembly 50 from moving in an upward direction. The clip 55 may be in elliptical or rectangular shape and made of any flexible material, for example, plastic. The clip 55 may further comprise one or more protrusions. See FIG. 5.

The locking mechanism 54 ensures a smooth downward motion of the spike assembly 50 with low actuation force and prevents reuse of the device 10 by retaining the spike assembly 50 in a downward position due to a high retaining force (relative to the actuation force). The locking mechanism 54 may prevent return motion at any point during the downward movement of the shaft 51.

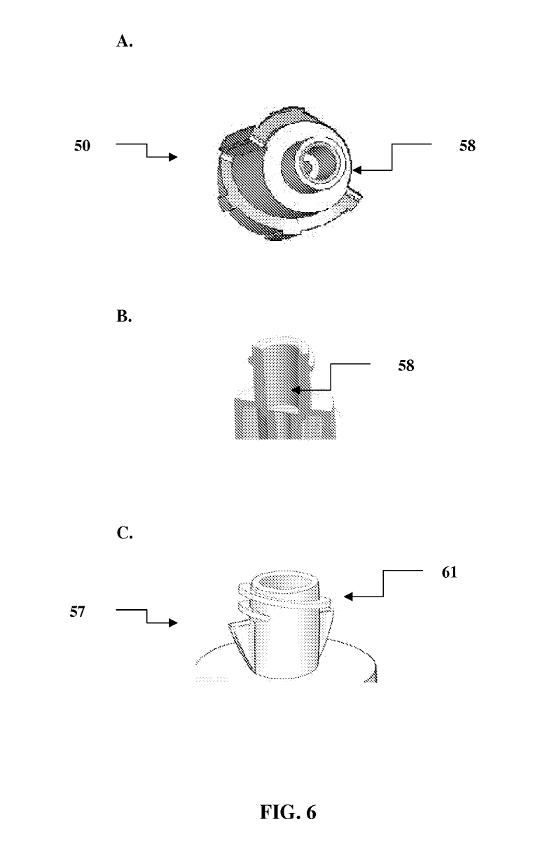

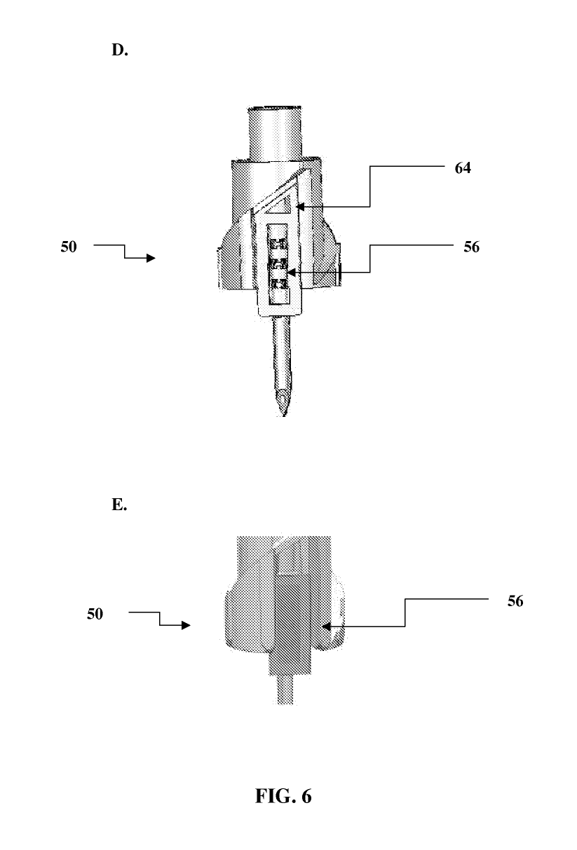

The spike assembly 50 may include a male element 57 extending from the top surface of the spike assembly 50 in an upward direction opposite the shaft 51. The male element 57 may be configured to receive a second receptacle, such as a syringe. The male element 57 may include an inner bore 58 and an outer surface 59. The outer surface 59 may include a thread 61 for mating with the second receptacle. For example, a user may fasten a second receptacle (e.g., threaded syringe) to the thread 61 on the outer surface 59 of the male element 57. The user would continue to turn the second receptacle until the second receptacle makes contact with the top surface 60 of the spike assembly 50. The user would then know the second receptacle is fully secured to the male element 57. See FIG. 6.

The spike assembly 50 may further include one or more filtering mechanisms. For example, a fluid filter may be located within the inner bore 58 of the spike assembly 50 to filter any liquid that is introduced into the spike assembly 50. Furthermore, an air filter 56 may be located on the spike assembly 50 to filter any air that is introduced into the receptacle 12. The air filter 56 may be made from any of a variety of materials (e.g., nylon, PVDF, PE). The air filter 56 may also comprise pores (e.g., 0.001-200 μm). See FIG. 6.

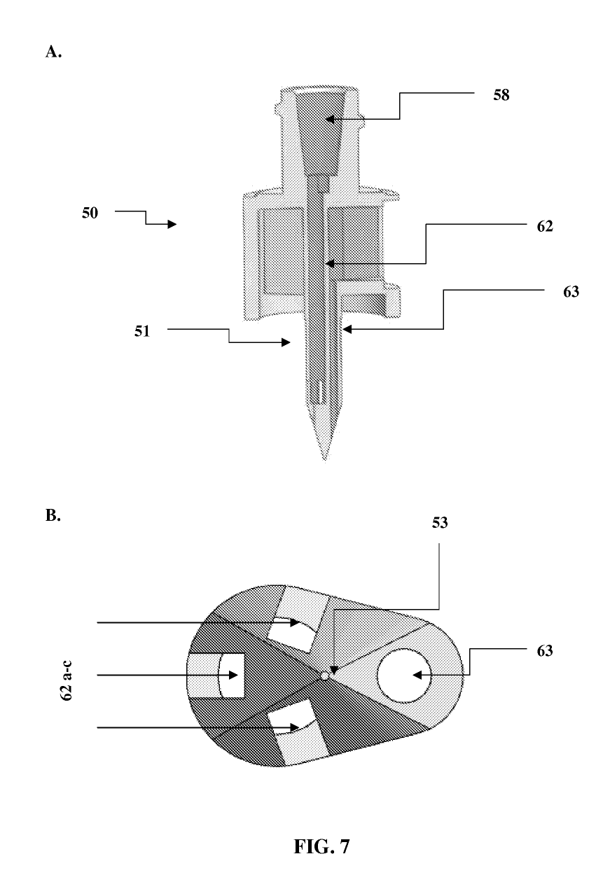

The shaft 51 of the spike assembly 50 may include a first longitudinal channel 62. The first longitudinal channel 62 establishes communication between the receptacle 12 and the inner bore 58 of the male element 57. The first channel 62 may allow fluid to pass through the shaft 51 of the spike assembly 50 and into the receptacle 12. The first channel 62 may branch into two or more channels. For example, the first channel 62 may branch (or trifurcate) into three channels 62a-c. See FIG. 7.

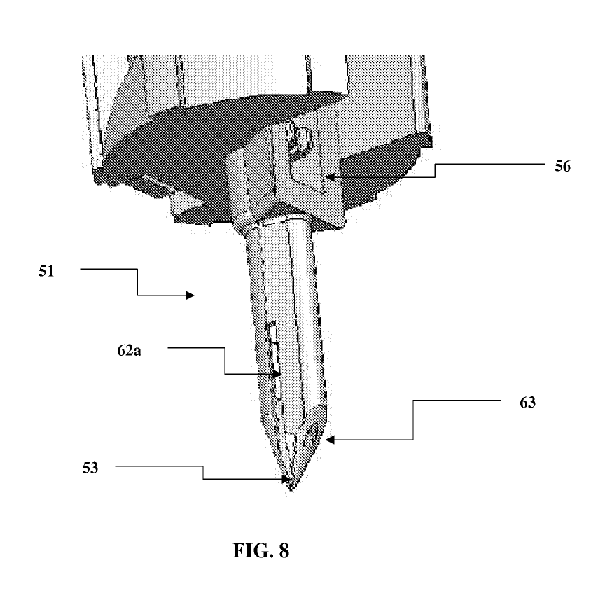

The shaft 51 of the spike assembly 50 may include a second longitudinal channel 63. The end of the second channel 63 may be located opposite the pointed end 53 of the shaft 51 may interface to an air channel return. The air channel return interfaces with an air filter 56. The second channel 63 functions as an air path to allow air to travel out of the receptacle 12 through the shaft 51 of the spike assembly 50, into the air channel return, through the filter 56, and then through a vent 64 located on the spike assembly 50. The air exiting the vent 64 is vented to the atmosphere surrounding the device 10. See FIGS. 6 and 8.

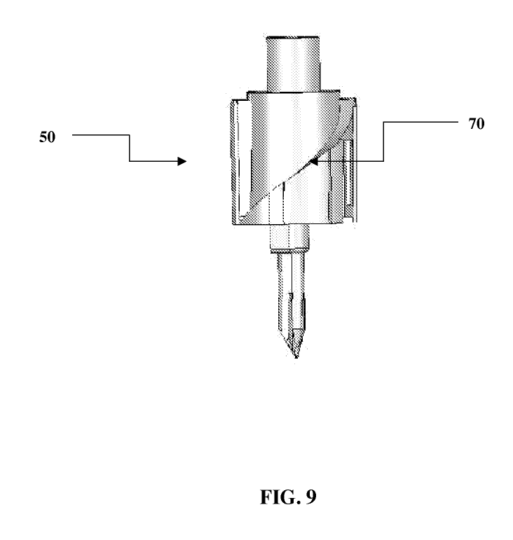

The device 10 may also include an actuating mechanism which moves the spike assembly 50 into the activated position. The actuating mechanism may comprise a first helical path 70 located on an outer surface of the spike assembly 50 and a corresponding second helical path 81 located on the inner projection member of the outer cover 80, the first and second helical paths (70, 81) interacting to rotate and push the spike assembly 50 downwardly into the activated position so the shaft 51 of the spike assembly 50 perforates the stopper 18. See FIG. 9.

In order to use the device 10, a user may rotate the outer cover 80 a given number of degrees until the shaft 51 of the spike assembly 50 perforates the stopper 18. In one embodiment, as the user rotates the outer cover 80, the first and second helical paths (70, 81) interact to push the spike assembly 50 downward into the activated position and the clip 55 of the locking mechanism 54 engages the ridge 29 of the inner bore 34 of the inner sleeve 24, preventing the spike assembly 50 from moving in the upward direction. This mechanism may provide tactile and/or audible feedback for the user so that the user would know when the spike assembly 50 has completed the downward direction and activation has occurred. The device may also include alignment markers or color indicators located on the outer cover 80 and outer sleeve 40 as visual feedback for the user. For example, the outer cover 80 may include a slot or window which would reflect a color change when the device was activated (e.g., red to green).

In operation, and by way of example, as the spike assembly 50 travels in a direction towards the stopper 18, the feedback mechanism provides tactile feedback as the clip 55 of the locking mechanism 54 travels past the ridge 29 of the inner bore 34 of the inner sleeve 24. The tactile feedback may be felt by the user. Moreover, as the clip 55 of the locking mechanism 54 travels past the ridge 29 of the inner bore 34, a sound may be made such that the feedback mechanism also provides audible feedback.

As mentioned above, the device 10 may include a feedback mechanism that provides a user of the device 10 with feedback regarding operation of the device 10. For example, the feedback may indicate that the shaft 51 has traveled an optimum distance into the stopper 18. Alternatively, or in combination, the feedback may indicate that the spike assembly 50 has traveled an optimum distance within the inner sleeve 24 and that the user should not push the spike assembly 50 any further. Other examples of the feedback provided by the feedback mechanism are also possible.

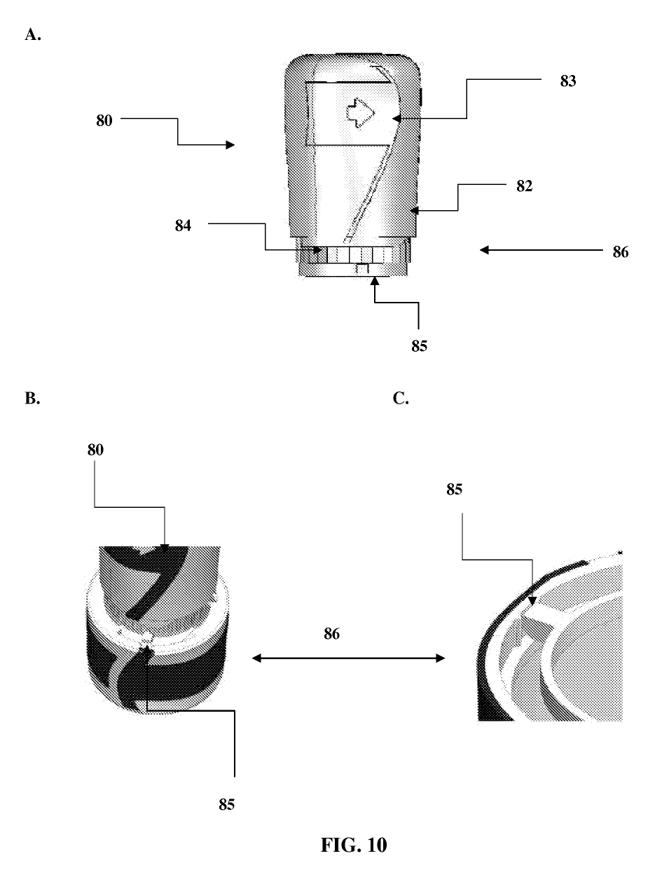

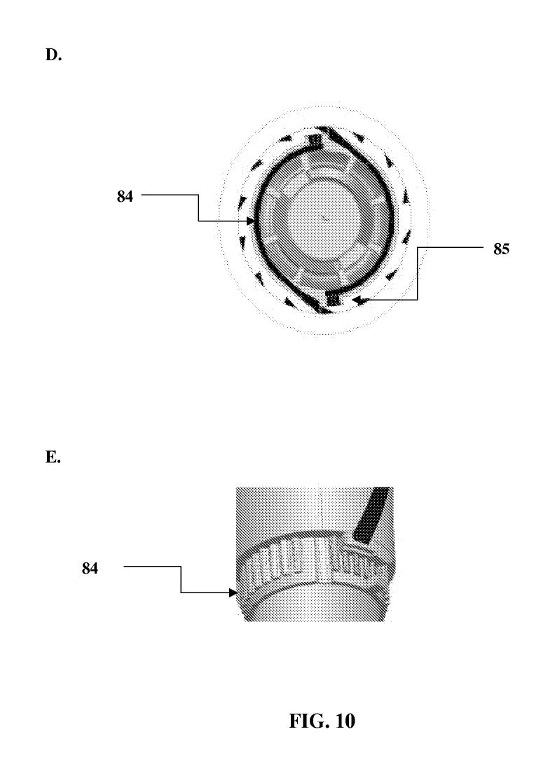

The surface 82 of the outer cover 80 may include direction markers 83 to indicate to a user which direction to turn the outer cover 80. The surface 82 of the outer cover 80 may further include alignment markers to indicate to the user when the actuating mechanism is aligned. The surface 82 of the outer cover 80 may be textured to facilitate gripping and rotating the cover 80 by a user. For example, the outer cover may include at least one finger grip. See FIG. 10.

In one embodiment, the device 10 may include a ratcheting mechanism to prevent the reverse motion of the outer cover 80, that is, preventing the return of the device 10 to its starting position after partial activation and thus, avoid potential contamination. One or more tabs 84 located on the first end 86 of the outer cover 80 align with the one or more slots 44 of the outer sleeve 40. The first end 86 of the outer cover 80 also includes one or more ribs 85 which engage the ridge 45 of the outer sleeve 40. As the outer cover 80 rotates, each rib 85 deflects over the ridge 45 and the rotation of the outer cover 80 cannot be reversed. See FIG. 10.

In a further embodiment, the device 10 may include a tamper-proof mechanism to indicate to a user whether the device 10 has been used. The tamper-proof mechanism may comprise any type of indicator, for example, a seal (e.g., perforated or frangible seal), a holographic label, or a tab.

In operation, the device 10 is in a disengaged position, that is, the shaft 51 of the spike assembly 50 is not piercing the stopper. To activate the device 10, a user may rotate the outer cover 80, for example, a given number of degrees, which pushes the spike assembly 50 downward toward the stopper 18. The shaft 51 of the spike assembly 50 may pierce the stopper 18, allowing access to the opening 16 of the receptacle 12. The contents of a second receptacle (e.g., pre-filled syringe) may then be introduced into the receptacle 12 to mix with the drug product. The mixed contents may then be pulled back into the second receptacle. A needle may then be secured to the second receptacle, and the complete and active drug product may be administered to a patient.

Assembly of the first end 25 of the inner sleeve 24 to the receptacle 12 may be carried out using various methods. For example, the inner sleeve 24 slides over the stopper 18 allowing the flexible skirt 26 to expand as the flexible skirt 26 passes over the lip 15 of the receptacle 12, and then the flexible skirt 26 may contract after passing over the lip 15 and the tabs 28 of the flexible skirt 26 grip the neck 14 of the receptacle 12. Furthermore, the outer sleeve 40 holds the flexible skirt 26 in place.

The device 10 may be activated by a user rotating the outer cover 80 and then pushing the outer cover 80 downward which would then cause the spike assembly 50 to perforate the stopper 18, or the user may simply push the outer cover 80 downward to cause the spike assembly 50 to perforate the stopper 18.

The device 10 may include a locking mechanism 54 comprising a barb lock as a means to prevent the upward movement of the spike assembly 50 after downward movement of the spike assembly 50 has occurred. The barb lock may be located in the inner sleeve and would be capable of flexing to lock the spike assembly 50 in an activated position in which the shaft 51 has perforated the stopper 18. For example, the barb lock may comprise spikes which would engage the side of the inner bore 34 of the inner sleeve 24. Once engaged, the barb lock prevents the spike assembly 50 from moving in an upward direction.

The device 10 may function as a channel 62 between two compartments (e.g., sterile vial or bag). For example, the device may maintain the separation of two components prior to activation. Upon activation of the device, the channel is opened, allowing the transfer of the two components, and thereby combining the components. In addition, the outer cover 80 and the inner sleeve 24 provide physical barriers, protecting the components from contamination.

### Attachment

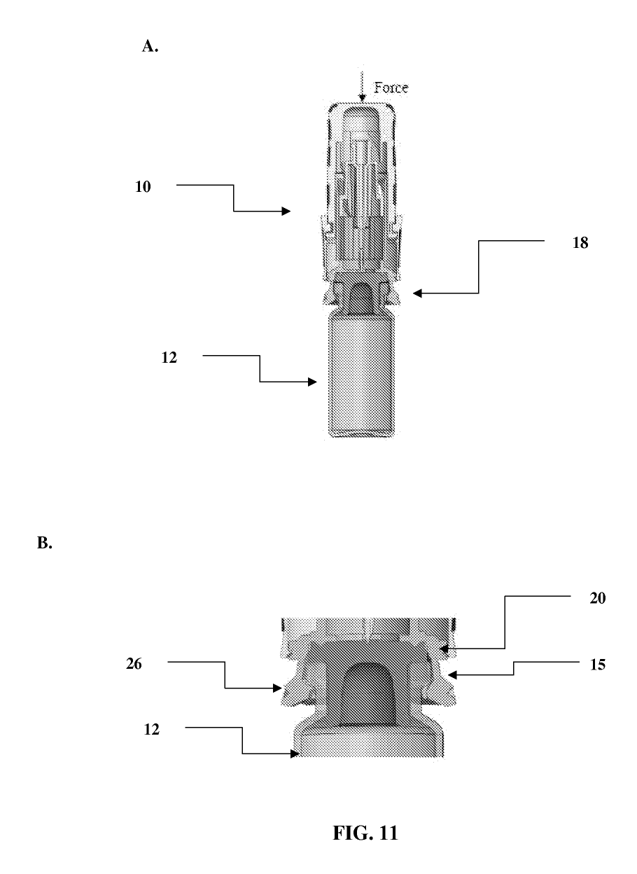

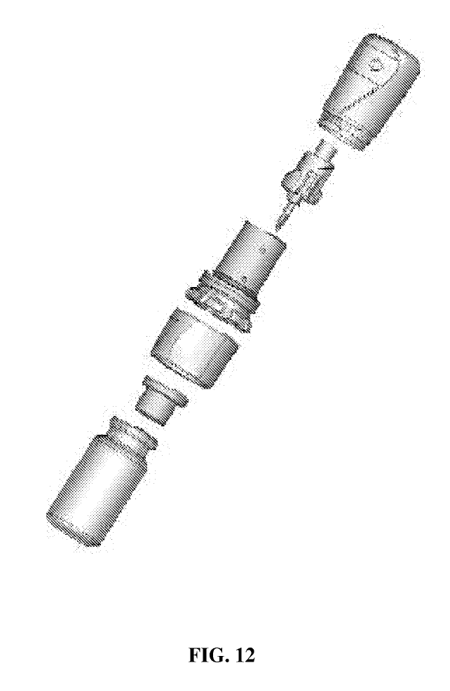

The device 10 may be attached to a receptacle 12 (e.g., a vial) by manual means or by automation. As an example of automation, the device 10 may be attached to a vial during a capping process. This process may involve applying a force to the top of the device 10 and transferring that force to the outer sleeve 40. The force drives the outer sleeve 40 downward, which causes the flexible skirt 26 to crimp around the lip 15 of the vial, the outer sleeve 40 locks over the flexible skirt 26, and the stopper 18 is compressed against the vial. FIG. 11A exemplifies the application of a force to the top of the device 10 and transferring that force to the outer sleeve 40 and FIG. 11B exemplifies the flexible skirt 26 crimping around the lip 15 of the vial.

### Pharmaceutical Compositions

The application also provides, in part, a device comprising a pharmaceutical composition. The compositions may be suitable for in vivo administration and are pyrogen free. The compositions may also comprise a pharmaceutically acceptable carrier. The phrase “pharmaceutically or pharmacologically acceptable” refers to molecular entities and compositions that do not produce adverse, allergic, or other untoward reactions when administered to an animal or a human. As used herein, pharmaceutically acceptable carrier includes any and all solvents, dispersion media, coatings, antibacterial and antifungal agents, isotonic and absorption delaying agents, and the like. The use of such media and agents for pharmaceutically active substances is well known in the art. Supplementary active ingredients also may be incorporated into the compositions.

A drug product may be prepared for administration as solutions of free base or pharmacologically acceptable salts in water, suitably mixed with a surfactant, such as hydroxypropylcellulose. Dispersions also may be prepared in glycerol, liquid polyethylene glycols, and mixtures thereof, and in oils. Under ordinary conditions of storage and use, these preparations contain a preservative to prevent the growth of microorganisms.

The pharmaceutical forms, suitable for injectable use, include sterile aqueous solutions or dispersions and sterile powders for the extemporaneous preparation of sterile injectable solutions or dispersions. The form should be sterile and should be fluid to the extent that easy syringability exists. It should be stable under the conditions of manufacture and storage and should be preserved against the contaminating action of microorganisms, such as bacteria and fungi. The carrier may be a solvent or dispersion medium containing, for example, water, ethanol, polyol (e.g., glycerol, propylene glycol, and liquid polyethylene glycol, and the like) sucrose, L-histidine, polysorbate-80, or suitable mixtures thereof, and vegetable oils. The prevention of the action of microorganisms may be brought about by various antibacterial an antifungal agents, for example, parabens, chlorobutanol, phenol, sorbic acid, thimerosal, and the like. The injectable compositions may include isotonic agents, for example, sugars or sodium chloride.

Sterile injectable solutions may be prepared by incorporating a drug product (e.g., FVII, FVIII, FIX, insulin, interferon) in the required amount in the appropriate solvent with various of the other ingredients enumerated above, as required, followed by filtered sterilization.

Generally, dispersions may be prepared by incorporating the various sterilized active ingredients into a sterile vehicle that contains the basic dispersion medium and the required other ingredients from those enumerated above. In the case of sterile powders for the preparation of sterile injectable solutions, methods of preparation include, for example, vacuum-drying and freeze-drying techniques that yield a powder of the active ingredient plus any additional desired ingredient from a previously sterile-filtered solution thereof.

Upon formulation, solutions may be administered in a manner compatible with the dosage formulation and in such amount as is therapeutically effective. “Therapeutically effective amount” is used herein to refer to the amount of a drug product that is needed to provide a desired level of the drug product in the bloodstream or in the target tissue. The precise amount will depend upon numerous factors, for example, the particular drug product, the components and physical characteristics of the therapeutic composition, intended patient population, mode of delivery, individual patient considerations, and the like, and can readily be determined by one skilled in the art, based upon the information provided herein.

The formulations may be easily administered in a variety of dosage forms, such as injectable solutions, and the like. For parenteral administration in an aqueous solution, for example, the solution should be suitably buffered, if necessary, and the liquid diluent first rendered isotonic with sufficient saline or glucose. These particular aqueous solutions are especially suitable for intravenous, intramuscular, subcutaneous and intraperitoneal administration.

The frequency of dosing will depend on the pharmacokinetic parameters of the agents and the routes of administration. The optimal pharmaceutical formulation may be determined by one of skill in the art depending on the route of administration and the desired dosage (see, e.g., Remington's Pharmaceutical Sciences, Mack Publishing Co., Easton, Pa., 20^{th} edition, 2000, incorporated herein by reference). Exemplary dosing schedules include, without limitation, administration five times a day, four times a day, three times a day, twice daily, once daily, three times weekly, twice weekly, once weekly, twice monthly, once monthly, and any combination thereof.

The composition may also include an antimicrobial agent for preventing or deterring microbial growth. Non-limiting examples of antimicrobial agents suitable for the present invention include benzalkonium chloride, benzethonium chloride, benzyl alcohol, cetylpyridinium chloride, chlorobutanol, phenol, phenylethyl alcohol, phenylmercuric nitrate, thimersol, and combinations thereof.

An antioxidant may be present in the composition as well. Antioxidants may be used to prevent oxidation, thereby preventing the deterioration of the preparation. Suitable antioxidants for use in the present invention include, for example, ascorbyl palmitate, butylated hydroxyanisole, butylated hydroxytoluene, hypophosphorous acid, monothioglycerol, propyl gallate, sodium bisulfite, sodium formaldehyde sulfoxylate, sodium metabisulfite, and combinations thereof.

A surfactant may be present as an excipient. Exemplary surfactants include: polysorbates such as Tween®-20 (polyoxyethylenesorbitan monolaurate) and Tween®-80 (polyoxyethylenesorbitan monooleate) and pluronics such as F68 and F88 (both of which are available from BASF, Mount Olive, N.J.); sorbitan esters; lipids such as phospholipids such as lecithin and other phosphatidylcholines, phosphatidylethanolamines, fatty acids and fatty esters; steroids such as cholesterol; and chelating agents such as EDTA, zinc and other such suitable cations.

Acids or bases may be present as an excipient in the composition. Non-limiting examples of acids that may be used include hydrochloric acid, acetic acid, phosphoric acid, citric acid, malic acid, lactic acid, formic acid, trichloroacetic acid, nitric acid, perchloric acid, phosphoric acid, sulfuric acid, fumaric acid, and combinations thereof. Examples of suitable bases include, without limitation, sodium hydroxide, sodium acetate, ammonium hydroxide, potassium hydroxide, ammonium acetate, potassium acetate, sodium phosphate, potassium phosphate, sodium citrate, sodium formate, sodium sulfate, potassium sulfate, potassium fumerate, and combinations thereof.

The amount of any individual excipient in the composition may vary depending on the activity of the excipient and particular needs of the composition. Typically, the optimal amount of any individual excipient may be determined through routine experimentation, that is, by preparing compositions containing varying amounts of the excipient (ranging from low to high), examining the stability and other parameters, and then determining the range at which optimal performance is attained with no significant adverse effects. Generally, the excipient may be present in the composition in an amount of about 1% to about 99% by weight, from about 5% to about 98% by weight, from about 15 to about 95% by weight of the excipient, with concentrations less than 30% by weight. These foregoing pharmaceutical excipients along with other excipients are described in “Remington: The Science & Practice of Pharmacy,” 19 ed., Williams & Williams, (1995); the “Physician's Desk Reference,” 52 ed., Medical Economics, Montvale, N.J. (1998); and Kibbe, A. H., Handbook of Pharmaceutical Excipients, 3 Edition, American Pharmaceutical Association, Washington, D.C., 2000.

### Kits

The invention further provides kits that may be used, for example, by patients or healthcare providers for reconstituting a drug prior to administration of the drug to a subject in need of treatment. The kit may comprise a device as described herein and a prefilled diluent syringe. The kit may further comprise an infusion set. In another embodiment, the kit may also comprise an alcohol swab, a cotton pad, and a bandage.

The devices, methods, and materials described herein are intended to be representative examples of the invention, and it will be understood that the scope of the invention is not limited by the scope of the examples. Those skilled in the art will recognize that the invention may be practiced with variations on the disclosed devices, methods, and materials, and such variations are regarded as within the ambit of the invention.

1. A device comprising:
a receptacle including an opening surrounded by a neck;
an inner sleeve including a first end, a second end, and an inner bore having a central aperture, the first end having a flexible skirt that is secured to the receptacle, the flexible skirt including one or more protrusions extending outwardly from the inner bore,
an outer sleeve including a first end and a second end, the outer sleeve surrounding the flexible skirt of the inner sleeve which pushes against the flexible skirt to secure the inner sleeve to the receptacle;
a stopper located in the opening of the neck of the receptacle, the stopper including a portion capable of being perforated;
a spike assembly adapted to slide along the inner bore of the inner sleeve, the spike assembly having a shaft capable of perforating the stopper;
an outer cover surrounding the spike assembly and the inner sleeve and having an inner projection member extending downwardly from the top of the outer cover;
a locking mechanism including a clip coaxially aligned with the shaft of the spike assembly, the clip capable of flexing to lock the spike assembly in an activated position in which the shaft is perforating the stopper; and
an actuating mechanism for moving the spike assembly into the activated position.

2. The device of claim 1, wherein the outer sleeve includes a lip which fits underneath the webbed protrusions of the flexible skirt to hold the flexible skirt in place.

3. The device of claim 1, wherein the outer sleeve includes one or more slots and one or more ridges.

4. The device of claim 1, wherein the clip of the locking mechanism further includes one or more protrusions.

5. The device of claim 1, wherein the spike assembly further includes a male element for receiving a second receptacle.

6. The device of claim 5, wherein the male element includes an inner bore and an outer surface including a thread.

7. The device of claim 5, wherein the second receptacle is a syringe.

8. The device of claim 1, wherein the spike assembly further includes one or more tabs which engage the one or more openings of the inner sleeve.

9. The device of claim 5, wherein the spike assembly includes a filtering mechanism and at least one channel for establishing fluid communication between the inside of the receptacle and the inner bore of the male element.

10. The device of claim 1, wherein the shaft of the spike assembly has a branched fluid channel and one air channel.

11. The device of claim 1, wherein the locking mechanism is located in the inner sleeve.

12. The device of claim 1, wherein the locking mechanism is secured to the spike assembly.

13. The device of claim 1, wherein the spike assembly includes at least one rib located on the surface of the spike assembly for aligning the spike assembly with the inner sleeve.

14. The device of claim 1, wherein the outer cover includes at least one finger grip.

15-29. (canceled)

30. A method of actuating a device having a receptacle, an inner sleeve secured to the receptacle, and a stopper located between the receptacle and the inner sleeve, the method comprising:
providing a spike assembly adapted to slide along an inner bore of the inner sleeve, the spike assembly having a shaft capable of perforating the stopper, the spike assembly further including a first helical path on an outer surface;
providing an outer cover surrounding the spike assembly and the inner sleeve and having an inner projection member extending downwardly from the top of the outer cover, the outer cover further including a second helical path located on the inner projection member;
rotating the outer cover so the second helical path interacts with the first helical path to rotate and push the spike assembly downwardly into an activated position in which the shaft of the spike assembly perforates the stopper; and
locking the spike assembly in the activated position by a locking mechanism.

31. A kit comprising
the device of claim 1; and
a prefilled diluent syringe.

32-34. (canceled)

35. The device of claim 1, wherein the protrusions are webbed protrusions comprising at least two tabs that grip the neck of the receptacle.

36. The device of claim 1, wherein the actuating mechanism is comprised of
a first helical path located on an outer surface of the spike assembly and a corresponding second helical path located on the inner projection member of the outer cover, such that the first and second helical paths interacting to rotate and push the spike assembly downwardly into the activated position so the shaft of the spike assembly perforates the stopper.
